(19) United States
(12) Patent Application Publication
(10) Pub. No.: US 2009/0165330 A1
(43) Pub. Date: Jul. 2, 2009

(54) Domestic appliance for the care of items of washing and method for removal of lint from such a domestic appliance

(75) Inventor: Uwe-Jens Krausch, Brieselang (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munchen (DE)

(21) Appl. No.: 12/313,871

(22) Filed: Nov. 24, 2008

(30) Foreign Application Priority Data
Dec. 27, 2007 (DE) 10 2007 062 783.3

(51) Int. Cl. F26B 3/02; F26B 21/00; D06F 58/04

(52) U.S. Cl. 34/480; 34/82; 34/130

(57) ABSTRACT

The invention relates to a domestic appliance for care of items of washing, with a drum for receiving the items of washing and a process air supply through which process air is able to be directed to and through the drum, a lint filter, which is arranged in the direction of flow of the process air after the drum and is embodied for filtering the lint contained in the process air and a sensor for detecting at least one parameter of the process air, with the lint filter and the sensor being arranged so that lint collected on the sensor can be automatically removed by the lint filter when the lint filter is removed from its installation position in the domestic appliance. The invention also relates to a method for removing lint from a domestic appliance for the care of items of washing.

### BACKGROUND OF THE INVENTION

The invention relates to a domestic appliance for the care of items of washing, with a drum for accepting the items of washing and a process air supply through which process air can be directed to and through the drum, a lint filter which is arranged in the direction of flow of the process air after the drum and for filtering the lint contained in the process air and a sensor for detecting at least one parameter of the process air. The invention further relates to a method for removing lint from a domestic appliance for the care of items of washing.

A domestic appliance for the care of items of washing, especially a tumble dryer, is known from respective publications EP 1 788 142 A2, US 2007/0107250 A1 and WO 2007/057260 A1, with a drum for accepting the items of washing and a process air supply through which process air is able to be directed to and through the drum, as well as a lint filter which is arranged in the direction of flow of the process air after the drum and for filtering out lint contained in the process air. The presence of a sensor, as mentioned at the start of this document, is not confirmed explicitly in any of these publications. It is however normal to use sensor systems in a tumble dryer, especially for temperature measurements.

### BRIEF SUMMARY OF THE INVENTION

For control of a tumble dryer a sensor system comprising at least one sensor is provided to enable the drying process to be monitored. For this purpose a sensor is used, especially in the process air stream, which is embodied for example for determining the temperature and humidity in the process air stream. Such a sensor must however maintain its function over the entire lifetime since, in addition to optimum control of the process, the sensor must also ensure the safety of the appliance. In addition it is known that a lint filter is used in a tumble dryer, with the filter being provided for filtering out the lint contained in the process air stream after the drum and able to be taken out of the domestic appliance to allow a user to remove the accumulated lint from it.

A sensor is used in an area of the tumble dryer in which it comes into contact with the process air stream. The lint is very largely removed by the lint filter, but fine lint particles still remain in the system which can pass through the lint filter of bypasses and then possibly build up on the sensor. In particular obstacles to the flow as well as areas where the flow velocity is slowed down form possible locations in this connection at which the lint not filtered out can be deposited. Under these circumstances lint can build up on correspondingly positioned sensors, even if they are arranged in the direction of flow beyond the lint filter. The operability of the sensor can be adversely affected by a lint buildup of this nature; for example a function-relevant time constant increases, or the sensitive surface, especially of a moisture sensor, will become obscured.

An object of the present invention is to create a domestic appliance for the care of items of washing as well as a method in which the lint collected on a sensor for detecting at least one parameter of the process air can be removed in a straightforward and reliable manner.

An inventive domestic appliance for the care of items of washing comprises a drum for accepting the items of washing. In addition the domestic appliance features a process air supply, through which process air can be directed to the drum and through the drum. Furthermore the domestic appliance features a lint filter which is arranged in the direction of flow of the process air after the drum and is embodied for filtering out the lint contained in the process air. In addition the domestic appliance contains at least one sensor for detecting at least one parameter of the process air, which is thus especially arranged so that it comes into contact with the process air and thereby lint to be found in the process air flow can build up on this sensor. The lint filter and the sensor are arranged in the domestic appliance so that, when the lint filter is removed from its installation position in the domestic appliance, the lint accumulated on the sensor is able to be removed automatically by the lint filter. A construction is thus created in which the removal of the lint adhering to the sensor can be carried out in a simple and reliable manner. The position of the lint filter and of the sensor in the appliance is selected so that the removal of lint from the sensor is carried out practically automatically at the same time as the lint filter is taken out of the appliance. This can also mean that, regardless of the accessibility of the sensor, the sensor no longer has to be cleaned separately, but is practically cleaned automatically when the lint filter is taken out. Such an arrangement also allows the sensor to always be cleaned as well when the lint filter is taken out of the domestic appliance for cleaning. This means that cleaning of the sensor can also no longer be forgotten or overlooked. The long-term reliable and correct functionality of the sensor can be guaranteed and an undesired disproportionate lint buildup prevented.

In addition this enables the sensor to be built into the domestic appliance so that there no longer needs to be unrestricted access to it for direct cleaning but it is sufficient for it to be positioned in relation to the lint filter so that when the filter is taken out the lint can be cleaned off the sensor automatically.

Preferably there is provision for the lint filter to wipe past the sensor as it is being removed from the domestic appliance and for the lint to be able to be wiped off the sensor. This is an especially simple embodiment of the cleaning of the sensor, since no other expensive components are necessary for this embodiment. In addition a simple wiping past the sensor allows any undesired force exerted on the latter to be prevented and thereby also possible damage to the sensor to be avoided. The precedence of the wiping action thus enables an especially protective and yet effective removal of the lint from the sensor.

Preferably the lint filter features a wiping-off device embodied for removal of the lint on the sensor. There is thus provision for the lint filter to be specifically constructed so that, when it is taken out, the lint can be removed from the sensor in an especially effective and also gentle manner.

Preferably the separate wiping-off device for the lint to be removed from the sensor is permanently attached to the lint filter, especially integrated on the lint filter. In this case for example there is provision for a one-piece embodiment with the lint filter. On the one hand this arrangement enables a mechanically stable lint filter with wiping-off device to be created and simple manufacturing and thus also cost-effective manufacturing to be implemented. In addition this fixed arrangement, especially the integration, allows the positionally-stable permanent attachment of the wiping-off device on the lint filter to be guaranteed.

Preferably the wiping-off device has a brush-like part which is embodied for removing the lint from the sensor and for collecting this lint. In particular the brush-like part is designed so that after removal of the lint from the sensor the lint is automatically collected and thus automatically removed along with the lint filter from the domestic appliance. This makes it possible to avoid the lint wiped off the sensor being distributed into the process air supply in an undesired manner and being deposited again on other components or no longer being able to be removed. Thus, in addition to the automatic removal of lint from the sensor, the wiping-off device also guarantees its automatic disposal from the domestic appliance.

The domestic appliance is especially designed as a dryer. In this context there can be provision for the dryer to be embodied as a condensing dryer and to have a closed process air supply. However there can also be provision for the dryer to be realized as a vented air dryer and to have an open process air supply.

In the inventive method for removal of lint from a domestic appliance for the care of items of washing process air is directed by means a process air supply to and through a drum containing the items of washing to be handled. The lint contained in the process air after its exit from the drum is removed from the process air by a lint filter. Values of at least one in a parameter of the process air are detected by a sensor of the domestic appliance. Lint accumulated on the sensor is automatically removed by the lint filter when the lint filter is removed from its installation position. A highly efficient method for removing lint adhering to a sensor can thus be provided. The step of taking out the lint filter also performs the cleaning of the sensor at the same time. An independent separate cleaning step of the sensor is no longer necessary. This enables the permanent cleaning at a sensor to be guaranteed and the cleaning of the sensor not to be forgotten or carried out at irregular intervals. The functionality of the sensor can be improved in this way and thereby the overall reliable functionality of the domestic appliance guaranteed over the long term.

Preferably the removal path of the lint filter from the domestic appliance is designed in such a way that the lint filter wipes past the sensor and the lint is wiped off the sensor. It is thus specified, for the specific location and construction, how the lint filter is removed from the domestic appliance and automatically cleans the lint off the sensor during removal. This guided removal avoids a user removing the lint filter on a path which would not guarantee any cleaning or only guarantee a very inadequate cleaning of the sensor. If the removal path cannot be constructionally executed in any other way and is predetermined in its concept in this way, this guarantees reliable and effective cleaning of the sensor.

Preferably the lint is removed from the sensor by a wiping-off device arranged on the lint filter. The lint filter is thus technically so specifically designed that at a defined location it comprises a wiping-off device constructed separately for this purpose which guarantees the removal of lint from the sensor especially well.

The lint is preferably wiped away from the sensor by the wiping-off device and automatically collected for removal from the domestic appliance by the wiping-off device. The lint being wiped off the sensor and this wiped-off lint falling into the process air supply can be avoided in this way. The deposition of the wiped-off lint in inaccessible areas of the process air supply can be prevented in this way. This also means that it is no longer necessary for the lint wiped off the sensor to have to be removed from the process air supply or the domestic appliance by a further separate disposal step. With the wiping off of the lint from a sensor the device is additionally designed so that on the further removal path the lint also remains automatically on the wiping-off device and is taken out along with it. A straightforward and hygienic disposal is also guaranteed in this way.

### BRIEF DESCRIPTION OF THE DRAWINGS

Exemplary embodiments of the invention are explained in greater detail below with reference to the following drawings:

FIG. 1 is a schematic cross-sectional view of a domestic appliance embodied as a tumble dryer for care of items of washing; and

FIGS. 2a, 2b, 2c and 2d illustrate a sequence of views of a lint filter with a wiping-off device for cleaning a sensor.

### DETAILED DESCRIPTION OF EXEMPLARY EMBODIMENTS OF THE PRESENT INVENTION

In the exemplary embodiments the dryer 1 is shown as a condensing dryer, with the dryer 1 however also able to be embodied as a vented air dryer.

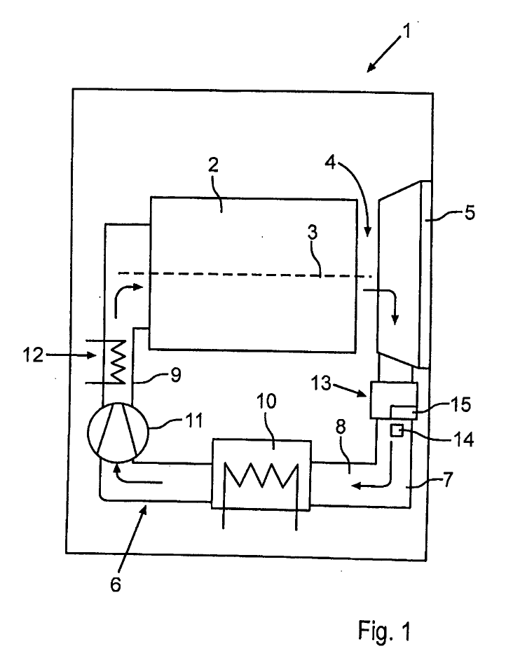

In accordance with FIG. 1 the dryer 1 includes a drum 2 for accepting items of washing to be dried, which is supported to allow its rotation around a horizontal axis 3. On its front side the drum 2 has a loading opening 4 which is able to be closed off by a door 5.

The dryer 1 further includes a closed process air supply 6, through which process air is guided in the circuit. The process air supply 6 comprises a duct system with a falling section 7 which represents the front area of the air duct. In addition the process air supply 6 comprises a horizontal section 8 adjoining the falling section 7 which then becomes a rising section 9 and then opens out in the drum 2.

The dryer 1 further includes a heat exchanger 10, which in the exemplary embodiment is coupled to the process air supply 6 in the horizontal section 8 or is arranged in this. The moisture-laden process air exiting from the drum 2 is cooled by the heat exchanger 10 and moisture is removed. The heat exchanger 10 can be a simple opposing-flow or crossflow heat exchanger. There can however also be provision for the dryer 1 to have a heat pump which comprises an evaporator and a condenser. The evaporator and the condenser are connected via a system of lines in which a compressor and a choke are also arranged. In the system of lines and the closed heat pump circuit comprising the evaporator, the condenser, the compressor and the choke, a working substance, especially a coolant, is conveyed in a circuit. The heat pump can be designed in accordance with the principle of the compressor heat pump, but can however also operate according to the principle of the Peltier heat pump.

In the dryer 1 equipped with a heat pump the heated, moisture-laden process air coming out of the drum 2 is cooled down, essentially in the evaporator of the heat pump, where the transferred heat is used for vaporization of a coolant employed in the heat pump circuit. The coolant of the heat pump evaporated as a result of the heat is fed via a compressor to the condenser of the heat pump, where, because of the condensation of the gaseous coolant, heat is released which is used before the heating up of the process air before its entry into the drum 2. The coolant circulates in the closed circuit, in which it arrives from the condenser via a choke back at the evaporator.

To convey the process air in the process air supply 6 a fan 11 is provided, which in the exemplary embodiment is arranged in the direction of flow of the process air before the drum 2 and is connected or coupled to the process air supply 6. The fan 11 thus acts as a pushing system. There can however also be provision for the fan 11 to be arranged in the direction of flow after the drum 2, for example in the falling section 7 and thus to be designed as an induction system.

The dryer 1 also includes a heating device 12, which is arranged before the drum 2. The heating device 12 is thermodynamically coupled to the process air and heats this before, its entry into the drum 2.

In addition the dryer 1 includes a lint filter 13, which is arranged in the falling section 7. The lint filter 13 is arranged in the flow direction of the process air in the exemplary embodiment before a sensor 14. The sensor 14 is embodied for detecting at least one parameter of the process air, for example the temperature and/or the humidity. There can also be provision for the sensor 14 to be arranged in the direction of flow of the process air in the process air supply 6 before the lint filter 13. The lint filter 13 includes a wiping-off device 15, which is arranged permanently on the lint filter 13, especially embodied in one piece with the latter. The wiping-off device 15 preferably comprises a brush-like part, which is embodied for wiping off and automatic collection of the lint collected on the sensor 14. To this end there is provision for the lint filter 13 with the wiping-off device 15 to be positioned in the dryer 1 so that it is moved past the sensor 14 when it is taken out and through its movement along the removal path for the wiping-off device 15 to wipe off the lint adhering to the sensor 14 and for the lint to be automatically collected and through the further removal of the lint filter 13 to be also automatically disposed of from the dryer 1.

The guide for embodying the removal path of the lint filter 13 from the domestic appliance or the dryer 1 is designed so that a user has only this one predetermined removal path and this automatically moves the lint filter 13 past the sensor 14. The accessibility and the removal of the lint filter 13 are in this case relatively simple and straightforward and it is of no consequence to the user whether the accessibility of the sensor 14 is accordingly provided since the automatic cleaning during removal of the lint filter 13 means that this not important for the user. The sensor 14 can thus also be arranged per se in an area of the dryer 1 relatively inaccessible to the user, the significant factor is that the arrangement is such that the path along which the lint filter 13 is taken out automatically cleans lint off the sensor 14. It is advantageous here for the lint filter 13 and the sensor 14 to be arranged relatively adjacent to each other.

Each time that the lint filter 13 is taken out, and thus during each provision for cleaning from the lint filter any lint collected in it, the sensor 14 is also automatically cleaned as well. The always reliable cleaning of the sensor 14 can thus be guaranteed and in addition forgetting to clean the sensor 14 can be avoided.

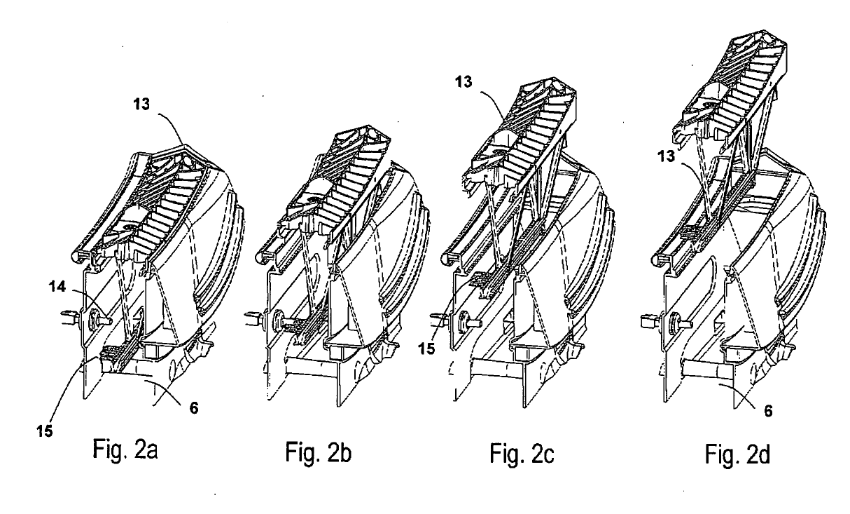

An exemplary embodiment can be seen from FIGS. 2a to 2d, of how, when a lint filter 13 is withdrawn from a process air supply 6 a wiping-off device 15 attached to the lint filter 13 cleans a sensor 14 in the process air supply 6. FIGS. 2a to 2d show an exemplary embodiment of a process air supply 6 with an upper side inflow area in the vicinity of which the door 5 (see FIG. 1) is located and in which the process air, after flowing through the drum 2 (cf. FIG. 1) flows in from top to bottom. FIG. 2a shows the lint filter 13, as it must be placed in the process air supply 6 during the operation of the dryer 1. The lint filter 13 has ribs arranged in a V-shape below an upper-side inflow part which bear a mesh or net not shown in the figures for capturing the lint carried along in the process air. These ribs end in a lower-side arrangement of two strips which are connected via a film hinge not visible in the figure. Thus one side of the lint filter 13 can be hinged up to enable the lint which has been deposited in the inside of the V-shaped structures formed by the ribs and the mesh or net located on them to be removed after the lint filter 13 has been taken out of the process air supply 6. FIGS. 2b to 2d show how the filter is taken out.

On its underside the lint filter 13 has a wiper 15 in the form of a brush, with this wiper 15 being located below a sensor 14 arranged in the process air supply 6, for example a temperature sensor, when the lint filter 13 is in the position needed for operation in accordance with FIG. 2a. If the lint filter 13 is now taken out of the process air supply 6, as shown in the sequence of FIGS. 2b to 2d, the wiper 15 wipes along or past the sensor 14 and thus cleans off fine lint from it which has not been captured by the lint filter 13 and which has been deposited on the sensor 14. The step of taking out the lint filter also performs the cleaning of the sensor at the same time. A special independent separate cleaning step of the sensor 14 is no longer necessary. This enables the permanent cleaning of the sensor 14 to be guaranteed and the cleaning of the sensor 14 not to be forgotten or only carried out at irregular intervals. This significantly improves the functionality of the sensor 14 and thereby guarantees the overall reliable functionality of the domestic appliance over the long term.

1. A domestic appliance for the care of items of washing, comprising:
a drum for accepting the items of washing and a process air supply, through which process air is able to be directed to and through the drum;
a lint filter which is arranged in the direction of flow of the process air after the drum and is embodied for filtering the lint contained in the process air; and
a sensor for detecting at least one parameter of the process air, wherein the lint filter and the sensor are arranged so that lint collected on the sensor can be automatically removed by the lint filter when the lint filter is removed from its installation position in the domestic appliance.

2. The domestic appliance of claim 1, wherein the lint filter moves past the sensor and the lint on the sensor is wiped off on its removal path from the domestic appliance.

3. The domestic appliance of claim 1, wherein the lint filter comprises a wiping-off device for removing the lint on the sensor.

4. The domestic appliance of claim 3, wherein the lint filter comprises the wiping-off device.

5. The domestic appliance of claim 3, wherein the wiping-off device has a brush-like part which is embodied for removal of the lint from the sensor and for collecting this lint.

6. The domestic appliance of claim 1, wherein the domestic appliance comprises a dryer.

7. A method for removing lint from a domestic appliance for the care of items of washing, comprising:
directing a process air supply to and through a drum;
filtering lint from the process air with a lint filter after exiting from the drum;
detecting a parameter of the process air; and
removing lint from the sensor by removing the lint filter from its installation position in the domestic appliance.

8. The method of claim 7, wherein the removing of the lint from the sensor comprises the lint filter wiping past the sensor while being removed from its installation position through a predetermined removal path.

9. The method of claim 7, wherein the removing of lint from the sensor comprises removing of lint by a wiping-off device on the lint filter.

10. The method of claim 7, further comprising collecting the lint removed from the sensor for removal from the domestic appliance by a wiping-off device.
